(19) United States
(12) Patent Application Publication
(10) Pub. No.: US 2016/0307486 A1
(43) Pub. Date: Oct. 20, 2016

(54) PIXEL STRUCTURE, DISPLAY SUBSTRATE AND DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Benlian WANG, Beijing (CN); Lei DAI, Beijing (CN)

(73) Assignees: BOE TECHNOLOGY GROUP CO., LTD., Beijing (CN); Chengdu BOE Optoelectronics Technology Co., Ltd., Chengdu, Sichuan (CN)

(21) Appl. No.: 14/786,097

(22) PCT Filed: Mar. 18, 2015
(86) PCT No.: PCT/CN2015/074505

§ 371 Date: Oct. 21, 2015

(30) Foreign Application Priority Data
Oct. 20, 2014 (CN) 201410559170.3

(51) Int. Cl. G09G 3/20

(52) U.S. Cl. CPC G09G 3/2003; G09G 2300/0452

(57) ABSTRACT

A pixel structure, a display substrate, and a display device are provided. The pixel structure includes a plurality of pixel arrays. Each pixel array comprises four pixels, each pixel includes: a first sub-pixel of a first color, a second sub-pixel of a second color, a third sub-pixel of a third color, and a fourth sub-pixel of a fourth color, and the first color, the second color, the third color, and the fourth color are different from each other. Each pixel array is a 4×4 array, and only one first sub-pixel of the first color, one second sub-pixel of the second color, one third sub-pixel of the third color, and one fourth sub-pixel of the fourth color are provided in each row, in each column and in each diagonal of each pixel array, respectively.

### TECHNICAL FIELD

Embodiments of the present disclosure relate to a pixel structure, a display substrate, and a display device.

### BACKGROUND

A conventional display screen generally adopts a pixel structure comprising three sub-pixels of Red, Green, and Blue (referred as RGB pixel structure). In order to improve brightness and reduce power consumption, a pixel structure comprising four sub-pixels of Red, Green, Blue, and White (referred as RGBW pixel structure) has been put forward in recent years; that is, a white transparent sub-pixel is added to the conventional RGB structure to improve the brightness and reduce the power consumption.

The sub-pixels in the RGBW pixel structure is generally arranged in strip manner (as shown in FIG. 1A) or in checkerboard manner (as shown in FIG. 1B). In the RGBW pixel structure in which the sub-pixels are arranged in strip manner, the number of source lines is needed to be increased by ⅓, and the increase of the number of source lines will lead to a reduction of aperture ratio of the pixel structure. In the RGBW pixel structure in which the sub-pixels are arranged in checkerboard manner, the number of gate lines is increased but the number of source lines is reduced by ⅓; in this case, though the cost is reduced, a horizontal scanning time is decreased such that there is a strong grainy sense in a display image.

### SUMMARY

According to embodiments of the present disclosure, a pixel structure is provided. The pixel structure comprises a plurality of pixel arrays. Each pixel array comprises four pixels, each pixel comprises: a first sub-pixel of a first color, a second sub-pixel of a second color, a third sub-pixel of a third color, and a fourth sub-pixel of a fourth color, and the first color, the second color, the third color, and the fourth color are different from each other. Each pixel array is a 4×4 array, and only one first sub-pixel of the first color, one second sub-pixel of the second color, one third sub-pixel of the third color, and one fourth sub-pixel of the fourth color are provided in each row, in each column and in each diagonal of each pixel array, respectively.

According to the embodiments of the present disclosure, a display substrate is provided. The display substrate has the pixel structure described as above.

According to the embodiments of the present disclosure, a display device is provided. The display device comprises the display substrate described as above.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1A and FIG. 1B are schematic views of a pixel structure according to one technique;

FIG. 2 is a schematic view I of a pixel structure according to embodiments of the disclosure;

FIG. 3A to FIG. 3L are schematic views of arranging a first sub-pixel, a second sub-pixel, a third sub-pixel, and a fourth sub-pixel according to the pixel structure shown in FIG. 2;

FIG. 4 is a schematic view of the four pixels of the pixel structure shown in FIG. 2;

FIG. 5 is a schematic view II of the pixel structure according to the embodiments of the disclosure;

FIG. 6A to FIG. 6I, are schematic views of arranging a first sub-pixel, a second sub-pixel, a third sub-pixel, and a fourth sub-pixel according to the pixel structure shown in FIG. 5;

FIG. 7 is a schematic view of the four pixels of the pixel structure shown in FIG. 5; and

FIG. 8 illustrates a schematic view III of the pixel structure according to the embodiments of the disclosure.

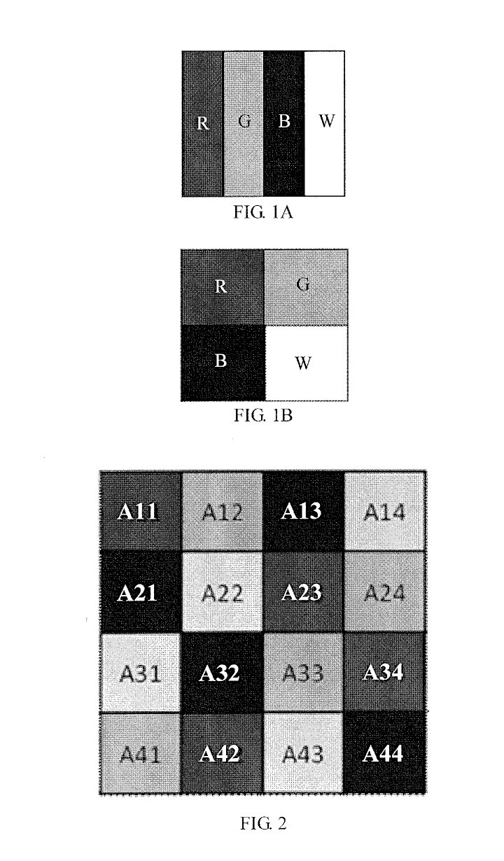

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

A pixel structure according to the embodiments of the disclosure comprises a plurality of pixel arrays, each pixel array comprises four pixels, each pixel comprises: a first sub-pixel of a first color, a second sub-pixel of a second color, a third sub-pixel of a third color, and a fourth sub-pixel of a fourth color, and the first color, the second color, the third color and the fourth color are different from each other. Each pixel array is a 4×4 array (that is, each pixel array comprises four columns and four rows), and only one first sub-pixel of the first color, one second sub-pixel of the second color, one third sub-pixel of the third color, and one fourth sub-pixel of the fourth color are provided in each row, in each column, and in each diagonal of the pixel array, respectively.

For example, each pixel is a 2×2 array.

FIG. 2 is a schematic view 1 of the pixel structure according to the embodiments of the disclosure. For example, as shown in FIG. 2, in each pixel array, the first sub-pixel, the second sub-pixel, the third sub-pixel, and the fourth sub-pixel are sequentially arranged in a first row; the third sub-pixel, the fourth sub-pixel, the first sub-pixel, and the second sub-pixel are sequentially arranged in a second row; the fourth sub-pixel, the third sub-pixel, the second sub-pixel, and the first sub-pixel are sequentially arranged in a third row; and the second sub-pixel, the first sub-pixel, the fourth sub-pixel, and the third sub-pixel are sequentially arranged in a fourth row.

For example, the first color, the second color, the third color, and the fourth color are respectively any one of red, green, blue, and white, and are different from each other. Namely, the first color is any one of red, green, blue, and white; the second color is any one of red, green, blue, and white; the third color is any one of red, green, blue, and white; the fourth color is any one of red, green, blue, and white; and the first color, the second color, the third color, and the fourth color are different from each other.

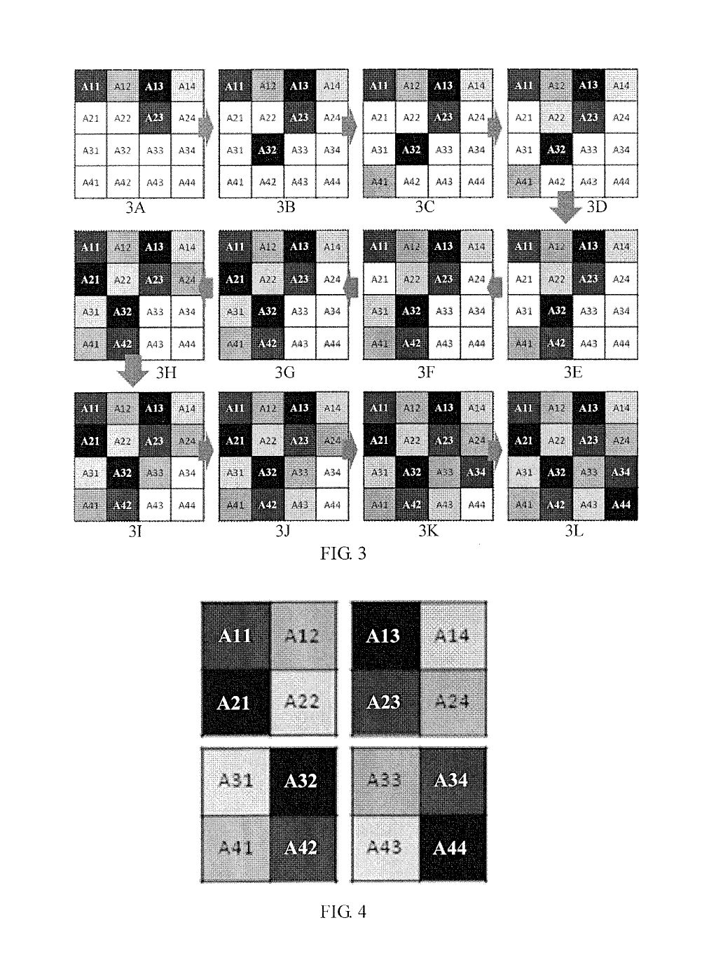

If the first color, the second color, the third color, and the fourth color respectively are red, green, blue, and white, based on the structure shown in FIG. 2, the first pixel of red (that is, red sub-pixel), the second pixel of green (that is, green sub-pixel), the third pixel of blue (that is, blue sub-pixel), and the fourth pixel of white (that is, white sub-pixel) are arranged as shown in FIG. 3. Firstly, the red sub-pixel, the green sub-pixel, the blue sub-pixel, and the white sub-pixel are sequentially filled in the first row of the pixel array, as shown in FIG. 3A. In order to ensure that only one red sub-pixel, one green sub-pixel, one blue sub-pixel, and one white sub-pixel are provided in each row, in each column and in each diagonal of the pixel array, respectively, the red sub-pixel cannot be filled in A21 and A22 of the second row A2 of the pixel array. For example, as shown in FIG. 3A, the red sub-pixel is filled in A23. Further, A32 cannot be filled with the green sub-pixel, and thus can only be filled with the blue sub-pixel, as shown in FIG. 3B. Further, A41 can be only filled with the green sub-pixel, as shown in FIG. 3C. A22 cannot be filled with the red sub-pixel, the green sub-pixel, or the blue sub-pixel, and thus can only be filled with the white sub-pixel, as shown in FIG. 3D. In the second row, there is only A42 left, and then the red sub-pixel is filled, as shown in FIG. 3E. Since A31 cannot be same as A41 and A32, A31 only can be filled with the white sub-pixel, as shown in FIG. 3F. A21 can be filled with the blue sub-pixel, as shown in FIG. 3G. A24 can be filled with the green sub-pixel, as shown in FIG. 3H. A33 is filled with the green sub-pixel, as shown in FIG. 31. A43 can be filled with the white sub-pixel, as shown in FIG. 3J. A34 can be filled with the red sub-pixel, as shown in FIG. 3K. A44 can be filled with the blue sub-pixel, as shown in FIG. 3L. Thus, the red sub-pixel, the green sub-pixel, the blue sub-pixel, and the white sub-pixel are sequentially arranged in the first row; the blue sub-pixel, the white sub-pixel, the red sub-pixel, and the green sub-pixel are sequentially arranged in the second row; the white sub-pixel, the blue sub-pixel, the green sub-pixel, and the red sub-pixel are sequentially arranged in the third row; the green sub-pixel, the red sub-pixel, the white sub-pixel, and the blue sub-pixel are sequentially arranged in the fourth row.

The pixel array shown in FIG. 2 comprises four pixels, each pixel is a 2×2 array, each pixel comprises: the first sub-pixel of the first color, the second sub-pixel of the second color, the third sub-pixel of the third color, and the fourth sub-pixel of the fourth color, and the first color, the second color, the third color, and the fourth color are different from each other. In order to be understood more easily, the pixel array shown in FIG. 2 has been divided into four parts as shown in FIG. 4 to clearly illustrate the four pixels comprised in the pixel array. It should be noted that, in practice, in order to avoid reduction in aperture ratio, there is substantially no gap or there is a gap as small as possible among the four pixels.

As shown in FIG. 4, only one first sub-pixel, one second sub-pixel, one third sub-pixel, and one fourth sub-pixel arc provided in each row, in each column and in each diagonal of the pixel array, respectively; and only one first sub-pixel, one second sub-pixel, one third sub-pixel, and one fourth sub-pixel are provided in each of the four pixels of the pixel array. Accordingly, the four colors of the sub-pixels can be uniformly mixed in the pixel array not only wholly but also partially; and further, in the pixel structure formed by the plurality of pixel arrays, the sub-pixels of four colors can be uniformly arranged, and thus color mixture can be more uniform and a display effect of an image can be improved.

FIG. 5 is a schematic view 11 of the pixel structure according to the embodiments of the disclosure. For example, as shown in FIG. 5, in each pixel array, the first sub-pixel, the second sub-pixel, the third sub-pixel, and the fourth sub-pixel are sequentially arranged in the first row; the fourth sub-pixel, the third sub-pixel, the second sub-pixel, and the first sub-pixel are sequentially arranged in the second row; the second sub-pixel, the first sub-pixel, the fourth sub-pixel, and the third sub-pixel are sequentially arranged in the third row; and the third sub-pixel, the fourth sub-pixel, the first sub-pixel, and the second sub-pixel are sequentially arranged in the fourth row.

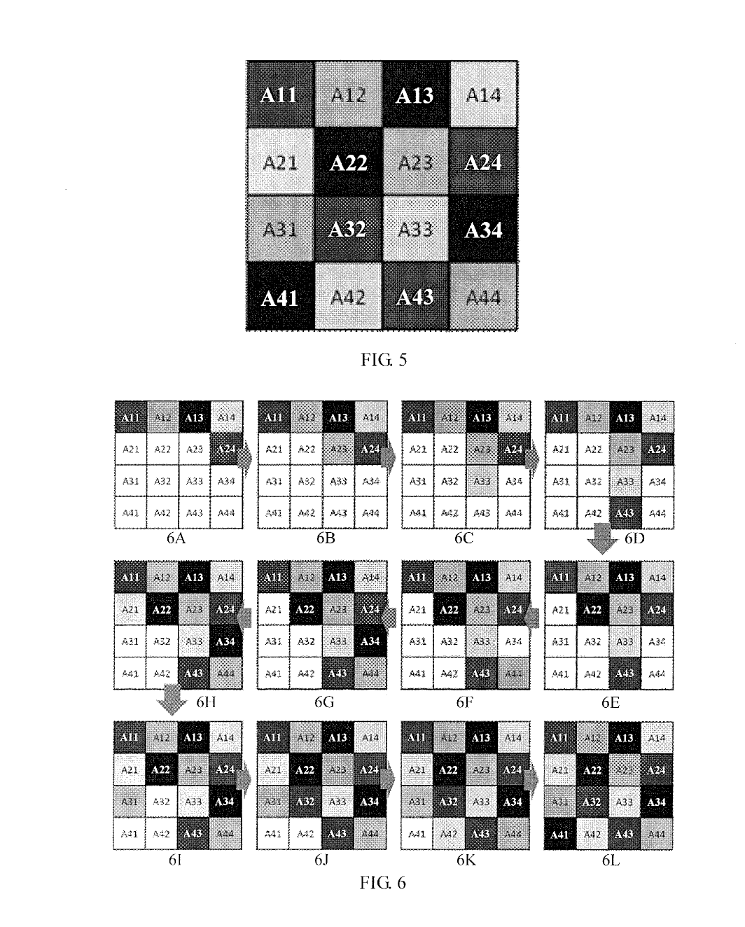

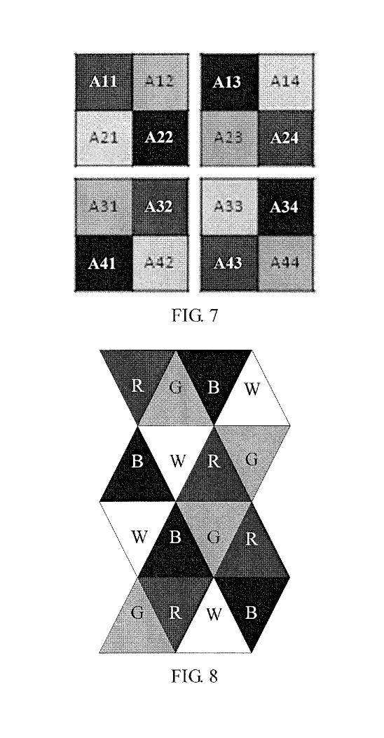

If the first color, the second color, the third color, and the fourth color respectively are red, green, blue, and white, based on the structure shown in FIG. 5, the red sub-pixel, the green sub-pixel, the blue sub-pixel, and the white sub-pixel are arranged as shown in FIG. 6. Firstly, the red sub-pixel, the green sub-pixel, the blue sub-pixel, and the white sub-pixel are sequentially filled in the first row of the pixel array, as shown in FIG. 6A. In order to ensure that only one red sub-pixel, one green sub-pixel, one blue sub-pixel, and one white sub-pixel are provided in each row, in each column and in each diagonal of the pixel arrays, respectively, the red sub-pixel cannot be filled in A21 and A22 of the second row A2 of the pixel array. For example, as shown in FIG. 6A, the red sub-pixel is filled in A24. In the case that A24 is filled with the red sub-pixel, since A23 cannot be of same color as A24, A13 and A14, A23 can only be filled with the green sub-pixel, as shown in FIG. 6B. A33 cannot be of same color as A13, A23 and A11, and thus A33 can only be filled with the white sub-pixel, as shown in FIG. 6C. There is only A43 left in the third row, and A43 only can be filled with the red sub-pixel, as shown in FIG. 6D. A22 cannot be of same color as A11, A12 and A33, and thus A22 only can be filled with the blue sub-pixel, as shown in FIG. 6E. In the diagonal line from upper left to lower right, there is only A44 left, A44 thus can only be filled with the green sub-pixel, as shown in FIG. 6F. There is only A34 left in the fourth row, and A34 can only be filled with the blue sub-pixel, as shown in FIG. 6G. In the second row, there is only A21 left, and A21 can only be filled with the white sub-pixel, as shown in FIG. 6H. Since A31 cannot be of same color as A33, A34 and A11, A31 can only be filled with the green sub-pixel, as shown in FIG. 61. There is only A32 left in the third row, and A32 can only be filled with the red sub-pixel, as shown in FIG. 6J. A42 can only be filled with the white sub-pixel, as shown in FIG. 6K. A41 can only be filled with the blue sub-pixel, as shown in FIG. 6L. Thus, the red sub-pixel, the green sub-pixel, the blue sub-pixel, and the white sub-pixel are sequentially arranged in the first row; the white sub-pixel, the blue sub-pixel, the green sub-pixel, and the red sub-pixel are sequentially arranged in the second row; the green sub-pixel, the red sub-pixel, the white sub-pixel, and the blue sub-pixel are sequentially arranged in the third row; and the blue sub-pixel, the white sub-pixel, the red sub-pixel, and the green sub-pixel are sequentially arranged in the fourth row.

The pixel array shown in FIG. 5 comprises four pixels, each pixel is a 2×2 array and each pixel comprises: one first sub-pixel of the first color, one second sub-pixel of the second color, one third sub-pixel of the third color, and one fourth sub-pixel of the fourth color, the first color, the second color, the third color, and the fourth color are different from each other. In order to be understood more easily, the pixel array shown in FIG. 5 has been divided into four parts as shown in FIG. 7 to clearly illustrate the four pixels comprised in the pixel array. It should be noted that, in practice, in order to avoid reduction in aperture ratio, there is substantially no gap or there is a gap as small as possible among the four pixels.

As shown in FIG. 7, only one first sub-pixel, one second sub-pixel, one third sub-pixel, and one fourth sub-pixel are provided in each row, in each column and in each diagonal of the pixel array, respectively; and only one first sub-pixel, one second sub-pixel, one third sub-pixel, and one fourth sub-pixel are provided in each of the four pixels of the pixel array. Accordingly, the four colors of the sub-pixels can be uniformly mixed in the pixel array not only wholly but also partially; and further, in the pixel structure formed by the plurality of pixel arrays, the sub-pixels of four colors can be uniformly arranged, and thus color mixture can be more uniform and the display effect of the image can be improved.

In the case that the first color, the second color, the third color, and the fourth color respectively are red, green, blue, and white, the pixel structure according to the embodiments of the disclosure only has the structures as shown in FIG. 2 and FIG. 5.

As described above, the first color, the second color, the third color, and the fourth color respectively are any one of red, green, blue, and white, and the first color, the second color, the third color, and the fourth color are different from each other. Specifically, the first color, the second color, the third color, and the fourth color respectively are red, green, blue, and white; or red, green, white, and blue; or red, blue, green, and white; or red, blue, white, and green; or red, white, blue, and green; or red, white, green, and blue; or green, red, blue, and white; or green, red, white, and blue; or green, white, red, and blue; or green, white, blue, and red; or green, blue, white, and red; or green, blue, red, and white; or blue, green, red, and white; or blue, green, white, and red; or blue, red, green, and white; or blue, red, white, and green; or blue, white, green, and red; or blue, white, red, and green; or white, red, green, and blue; or white, red, blue, and green; or white, green, blue, and red; or white, green, red, and blue; or white, blue, green, and red; or white, blue, red, and green. That is, in the case that the first color, the second color, the third color, and the fourth color are respectively any one of red, green, blue, and white, and are different from each other, the first color, the second color, the third color, and the fourth color have a total of 24 different combinations as described above. Each of the combinations has two structures as shown in FIG. 2 and FIG. 5, and a total of 48 kinds of pixel arrays are provided by the embodiments of the disclosure.

For example, each sub-pixel has an equal area, and is a quadrilateral.

For example, each sub-pixel is a square. Pixel arrays shown in FIG. 2 and FIG. 5 just illustrate the case that each sub-pixel is a square. A black matrix is generally provided between the sub-pixels, and light does not emit at the black matrix. In this case, square sub-pixels may increase a proportion of a light-emitting region of each sub-pixel, thereby improving a display effect.

FIG. 8 illustrates a schematic view III of the pixel structure according to the embodiments of the disclosure. For example, as shown in FIG. 8, each sub-pixel has an equal area, and is a triangle. Further, for example, each sub-pixel is an equilateral triangle.

It should be noted that the shape of each sub-pixel can be selected according to specific needs.

The embodiments of the disclosure further provide a display substrate, and the display substrate has any pixel structure described above. It should be noted that the display substrate of the embodiments may be a liquid display substrate or an OLED display substrate.

The embodiments of the disclosure further provide a display device, and the display device comprises the display substrate described above.

It should be noted that the display device of the embodiments of the disclosure may be: any product or component having a display function, such as a display panel, an electronic paper, a mobile phone, a tablet computer, a television, a laptop computer, a digital photo frame, a navigator, etc. In order to implement display or other functions, the display device may further comprise other functional components, which will not be repeated here.

In the above description, terms “first”, “second”, “third”, and “fourth” are used only for the purpose of description, but cannot be understood as indicating or implying relative importance. The term “a plurality of” refers to two or more, unless defined expressly otherwise.

The foregoing embodiments merely are exemplary embodiments of the disclosure, and not intended to define the scope of the disclosure, and the scope of the disclosure is determined by the appended claims.

The present application claims priority of Chinese Patent Application No. 201410559170.3 filed on Oct. 20, 2014, the disclosure of which is incorporated herein by reference in its entirety as part of the present application.

1. A pixel structure, comprising a plurality of pixel arrays, wherein
each pixel array comprises four pixels, each pixel comprises: a first sub-pixel of a first color, a second sub-pixel of a second color, a third sub-pixel of a third color, and a fourth sub-pixel of a fourth color, and the first color, the second color, the third color, and the fourth color are different from each other;
each pixel array is a 4×4 array, and only one first sub-pixel of the first color, one second sub-pixel of the second color, one third sub-pixel of the third color, and one fourth sub-pixel of the fourth color are provided in each row, in each column and in each diagonal of each pixel array, respectively.

2. The pixel structure according to claim 1, wherein
in each pixel array, the first sub-pixel, the second sub-pixel, the third sub-pixel, and the fourth sub-pixel are sequentially arranged in a first row; the third sub-pixel, the fourth sub-pixel, the first sub-pixel, and the second sub-pixel are sequentially arranged in a second row; the fourth sub-pixel, the third sub-pixel, the second sub-pixel, and the first sub-pixel are sequentially arranged in a third row; and the second sub-pixel, the first sub-pixel, the fourth sub-pixel, and the third sub-pixel are sequentially arranged in a fourth row.

3. The pixel structure according to claim 1, wherein
in each pixel array, the first sub-pixel, the second sub-pixel, the third sub-pixel, and the fourth sub-pixel are sequentially arranged in a first row; the fourth sub-pixel, the third sub-pixel, the second sub-pixel, and the first sub-pixel are sequentially arranged in a second row; the second sub-pixel, the first sub-pixel, the fourth sub-pixel, and the third sub-pixel are sequentially arranged in a third row; and the third sub-pixel, the fourth sub-pixel, the first sub-pixel, and the second sub-pixel are sequentially arranged in a fourth row.

4. The pixel structure according to claim 1, wherein
the first color, the second color, the third color, and the fourth color are respectively any one of red, green, blue, and white, and are different from each other.

5. The pixel structure according to claim 1, wherein each sub-pixel has an equal area, and is a quadrilateral.

6. The pixel structure according to claim 5, wherein each sub-pixel is a square.

7. The pixel structure according to claim 1, wherein each sub-pixel has an equal area, and is a triangle.

8. The pixel structure according to claim 7, wherein each sub-pixel is an equilateral triangle.

9. The pixel structure according to claim 1, wherein each pixel is a 2×2 array.

10. A display substrate, comprising the pixel structure according to claim 1.

11. A display device, comprising the display substrate according to claim 10.

12. The pixel structure according to claim 2, wherein
the first color, the second color, the third color, and the fourth color are respectively any one of red, green, blue, and white, and are different from each other.

13. The pixel structure according to claim 3, wherein
the first color, the second color, the third color, and the fourth color are respectively any one of red, green, blue, and white, and are different from each other.

14. The pixel structure according to claim 2, wherein each sub-pixel has an equal area, and is a quadrilateral.

15. The pixel structure according to claim 3, wherein each sub-pixel has an equal area, and is a quadrilateral.

16. The pixel structure according to claim 2, wherein each sub-pixel has an equal area, and is a triangle.

17. The pixel structure according to claim 3, wherein each sub-pixel has an equal area, and is a triangle.

18. The pixel structure according to claim 2, wherein each pixel is a 2×2 array.

19. The pixel structure according to claim 3, wherein each pixel is a 2×2 array.

20. The display substrate according to claim 10, wherein
in each pixel array, the first sub-pixel, the second sub-pixel, the third sub-pixel, and the fourth sub-pixel are sequentially arranged in a first row; the third sub-pixel, the fourth sub-pixel, the first sub-pixel, and the second sub-pixel are sequentially arranged in a second row; the fourth sub-pixel, the third sub-pixel, the second sub-pixel, and the first sub-pixel are sequentially arranged in a third row; and the second sub-pixel, the first sub-pixel, the fourth sub-pixel, and the third sub-pixel are sequentially arranged in a fourth row; or
in each pixel array, the first sub-pixel, the second sub-pixel, the third sub-pixel, and the fourth sub-pixel are sequentially arranged in a first row; the fourth sub-pixel, the third sub-pixel, the second sub-pixel, and the first sub-pixel are sequentially arranged in a second row; the second sub-pixel, the first sub-pixel, the fourth sub-pixel, and the third sub-pixel are sequentially arranged in a third row; and the third sub-pixel, the fourth sub-pixel, the first sub-pixel, and the second sub-pixel are sequentially arranged in a fourth row.
